(19) United States
(12) Patent Application Publication
(10) Pub. No.: US 2025/0104435 A1
(43) Pub. Date: Mar. 27, 2025

(54) RESTRICTED AREA MONITORING SYSTEM AND METHOD

(71) Applicant: Schlumberger Technology Corporation, Sugar Land, TX (US)

(72) Inventors: Antonio Massoni Abinader, Houston, TX (US); Velizar Vesselinov, Sugar Land, TX (US); Vigneshwaran Santhalingam, Houston, TX (US); Aniket Ulhasrao Joshi, Pune (IN); Dhananjaya Krishna, Sugar Land, TX (US)

(21) Appl. No.: 18/891,405

(22) Filed: Sep. 20, 2024

Related U.S. Application Data
(60) Provisional application No. 63/584,199, filed on Sep. 21, 2023.

(51) Int. Cl. G06V 20/52; G06T 7/00; G06V 40/10; G08B 13/196

(52) U.S. Cl. CPC G06V 20/52; G06T 7/0008; G06V 40/103; G08B 13/19682; G06T 2207/30232

(57) ABSTRACT

A method for operating a facility, the method including receiving real-time facility data representing an operational state of the facility, determining that an area of the facility is restricted based on the real-time facility data and a set of facility access rules that associates the operational facility state with at least one restricted area of the facility, and receiving image data representing at least a portion of the restricted area of the facility. The set of facility access rules may be selectively adjusted, and a portion of the received image data may be marked as the restricted within a graphical interface that is displayed on a screen that is associated with a user. A determination may then be made if there is a violation of the set of facility access rules based on the received image data, allowing for a corrective action to then be taken.

### PRIORITY APPLICATION

This application claims priority to, and the benefit of the earlier filing date of U.S. provisional patent application entitled “RIG RESTRICTED ZONE MONITORING SYSTEM AND METHOD”, filed Sep. 21, 2023, Ser. No. 63/584,199, pursuant to 35 USC 119, the contents of all of which are incorporated herein by reference.

### BACKGROUND

Various systems and tools are used to promote the health and safety of workers on oilfield facilities. Oilfield facilities such as rigs include large equipment that may move and present a safety hazard if workers are nearby while such equipment is active. Thus, certain parts of the facility may be restricted from human access for safety reasons at different times, while at other times, those same parts (“zones”) of the facility may be accessed for maintenance or otherwise used.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a simplified, schematic view of a facility system, according to an embodiment.

FIG. 3 illustrates an exemplary graphical interface used to view a restricted area of a facility and adjust a set of facility access rules, according to an embodiment.

FIG. 4 illustrates a flowchart of a method for operating a facility system, according to an embodiment.

FIG. 5 illustrates a schematic view of a computing system, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

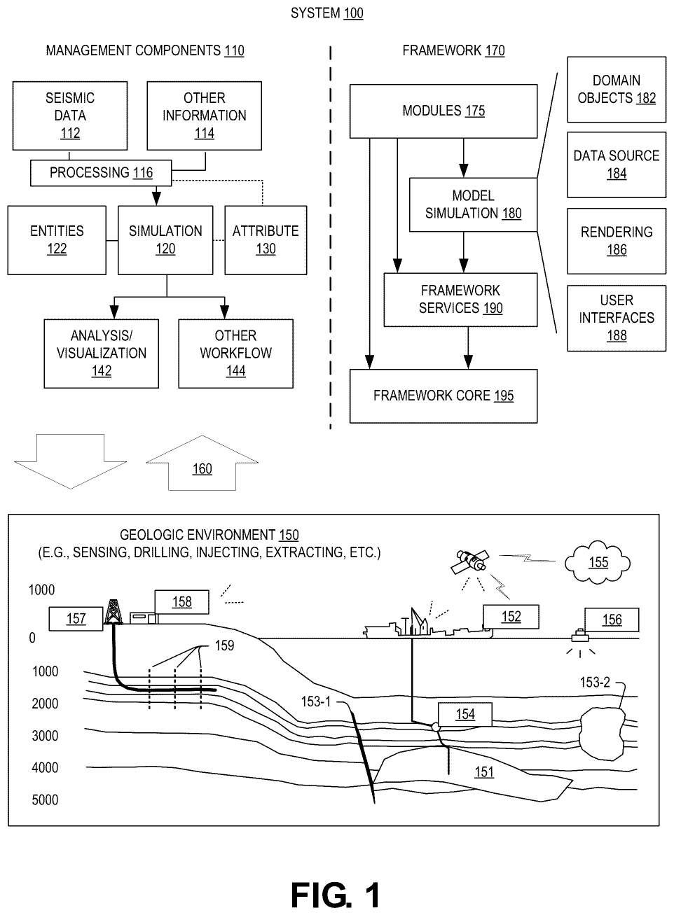

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component: 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 may include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the NET® framework, an object class encapsulates a module of reusable code and associated data structures. Object classes maybe used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Texas), the INTERSECT™ reservoir simulator (Schlumberger Limited, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Texas). The PETREL® framework provides components that allow for optimization of exploration and development operations. The PETREL® framework includes seismic to simulation software components that may output information for use in increasing reservoir performance, for example, by improving asset team productivity. Through use of such a framework, various professionals (e.g., geophysicists, geologists, and reservoir engineers) may develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software may include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications may display their data while the user interfaces 188 may provide a common look and feel for application user interface components.

As an example, the domain objects 182 may include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project may be accessed and restored using the model simulation layer 180, which may recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Restricted Area Monitoring System and Method

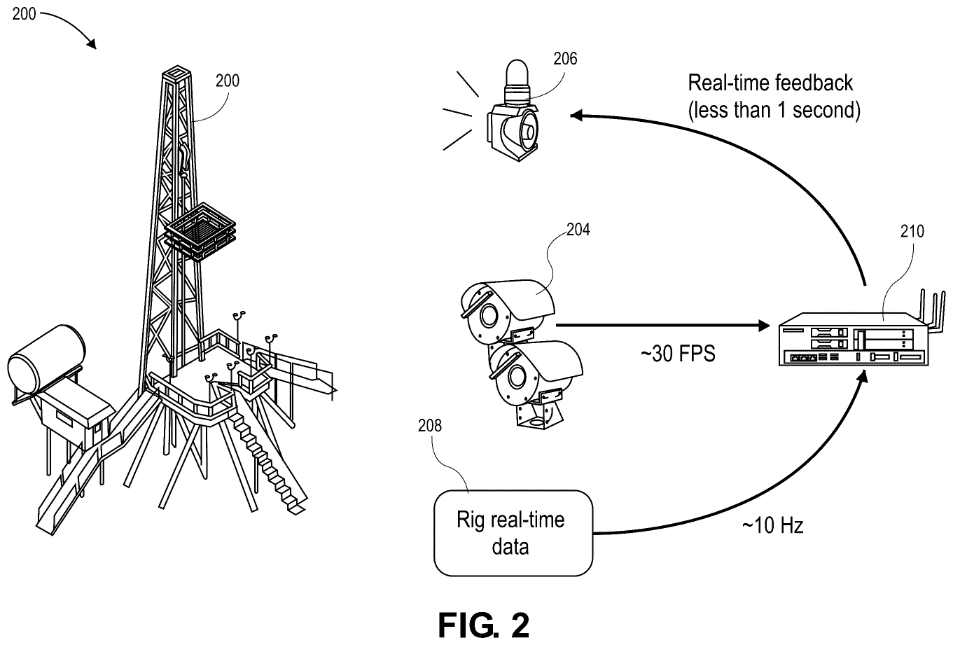

FIG. 2 illustrates a simplified schematic view of an oilfield facility system 200, according to an embodiment. The facility system 200 may generally include a facility 202 which may include a rig, a derrick, a rig floor, tubular handling equipment, drilling equipment, drilling controls, pipe racks, a catwalk, or the like. The facility system 200 may also include one or more optical devices or cameras 204, which may be strategically positioned on the facility 202 to acquire image data of different areas (or zones) on the facility 202. In particular, at different times during the operation of the facility 202, certain areas may be restricted, that is, not safe for human access. One or more of the cameras 204 may be positioned to permit visual monitoring of such potentially restricted areas.

According to certain embodiments, the image data may include optical data or video data captured or obtained from the optical devices 204. In certain embodiments, the image data may include image classification data, object detection data, image segmentation data, and image compression data.

The facility system 200 may also include alarm 206, which may be a visual, audible, or another type of alarm. The facility system 200 may further include facility sensors 208, which may generate real-time facility data, from which a facility state may be inferred. According to certain embodiments, the facility sensors 208 may include pressure sensors, temperature sensors, motion sensors, tachometers, or the like. In certain embodiments, real-time facility data may be generated from the tools and equipment on the facility 202 itself, for example drilling operational data or control system information associated with a hookload, drilling rotation speed, power consumption by and/or location of different pieces of equipment, or the like disposed on the facility 202. The facility state that is inferred from the received real-time facility data may correspond to certain equipment being active or in motion, which may, in turn, result in certain areas of the facility 202 being restricted based on rules, as will be described in greater detail below.

The facility system 200 may further include a processor 210 that may collect the real-time facility data from the facility sensors 208 and the cameras 204. According to certain embodiments, the processor 210 collects real-time facility data from the facility sensors 208 at a relative low frequency, for example 10 Hz, while the processor 210 may collect data from the cameras 204 at a relatively high frequency, for example 30 fps.

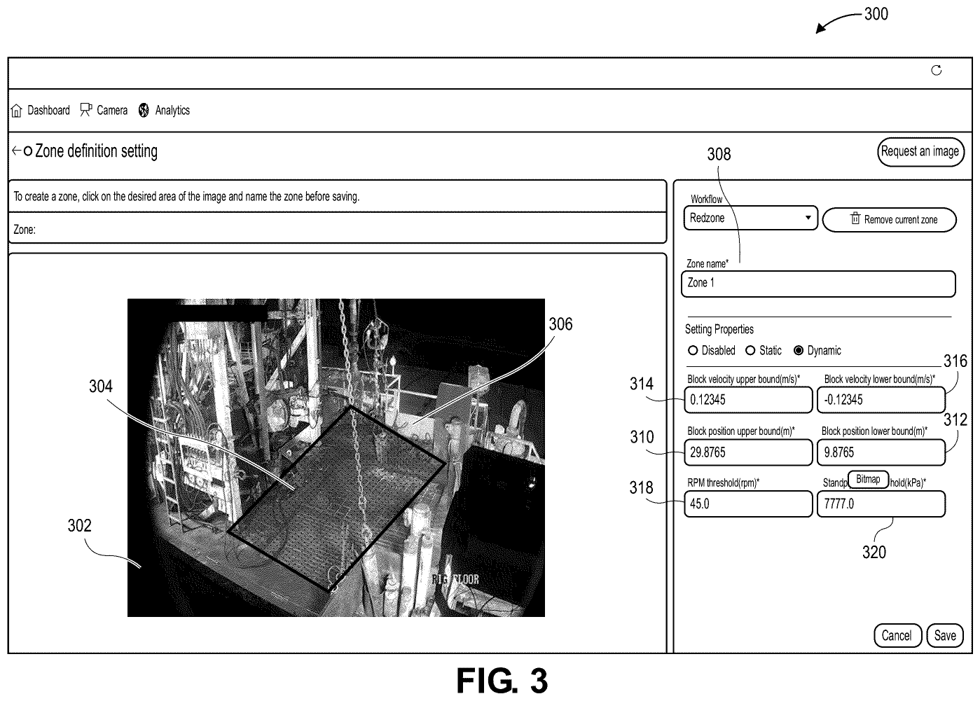

According to certain embodiments, a set of facility access rules may be customized or selected using a graphical interface 300 as seen in FIG. 3. The graphical interface 300 may display an image 302 received from one or more of the cameras 204, FIG. 2. The image 302 may be a real-time image or a pre-recorded image taken of a specific area or zone 306 of a portion of the facility 202, FIG. 2. The image 302 includes a demarcation 304 showing specifically where within the zone 306 that a specific set of facility access may be applied or enforced.

Using a plurality of tools within a settings window 308 on the graphical interface 300, a user may selectively change the size of the demarcation 304 within the zone 306 or change what the specific facility access rules are to be within the demarcation 304. For example, in certain embodiments after the facility state has been determined and the demarcation 304 has been defined within the applicable zone 306, the user may designate that the demarcation 304 is a strictly restricted area and that any worker detected within the demarcation 304 is a violation of the facility access rules, thereby activating the alarm 206, FIG. 2.

According to other embodiments, the user may designate that workers may freely enter the demarcation 304 provided that certain predetermined conditions are met, namely that the worker is wearing gloves, a hard hat, or other similar user-set prerequisite. AI trained image detection software stored on the processor 210, FIG. 2 may be configured to automatically determine if a worker has entered the demarcation 304, and if so, if the worker has met the required conditions. If the worker has not met the required conditions, the alarm 206, FIG. 2 may be activated.

According to certain embodiments, the user may designate that workers may freely enter the demarcation 304 provided that certain predetermined or scenario-specific prohibited activities are not performed by the worker while the detected facility state remains active. For example, as seen in FIG. 3, the user may set an upper position bound 310 and a lower position bound 312 for a block used to reel in drilling lines within the demarcation 304. Additionally, the user may establish other prohibited activities within the demarcation 304, including but not limited to a velocity upper bound of the block 314, a velocity lower bound of the block 316, a maximum RPM threshold 318, and/or a maximum pressure threshold 320. If one or more of the threshold boundary conditions are exceeded by a worker within the demarcation 304, the alarm 206, FIG. 2 may be activated by the processor 210.

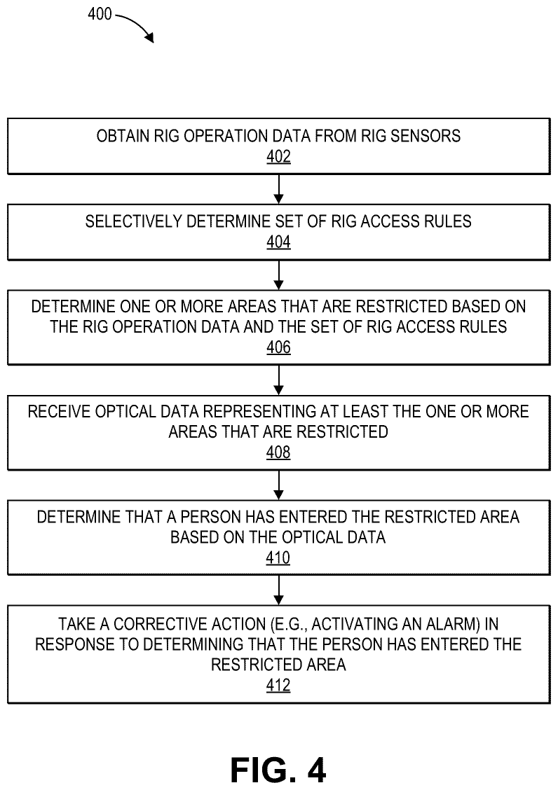

According to certain embodiments, the processor 210 may include a computer-readable medium storing instructions that, when executed by the processor 210, cause the processor 210 or another part of the facility system 200 to perform operations. Such operations may include the method 400 shown in the flowchart of FIG. 4. In this embodiment, the method 400 may include obtaining real-time facility data (or “facility operation data”) from the facility sensors 208 and/or the cameras 204, as at 402 and schematically depicted in FIG. 2. According to certain embodiments, the facility operation data may include light detection and ranging (LiDAR) data, satellite data, or data collected from sensors disposed on the facility equipment or worn by the workers within the facility. In certain embodiments, the sensors disposed on or worn by the workers may include wearables such as but not limited radio frequency identification (RFID) sensors.

A set of facility or facility access rules may be selectively determined, as at 404. According to certain embodiments, the set of facility access rules may include an adjustable safety threshold for workers on the facility 202. For example, the selected set of facility access rules may include that any worker detected within a restricted area of the facility 202 is deemed a violation of the rule set. According to certain embodiments, the restricted area may be predetermined or may be scenario-specific as determined by the selected set of facility access rules. For example, if the facility access rules include that the immediate area surrounding a specific piece of equipment is unsafe, the boundary of the restricted area may move with the equipment as it moves through the facility. In certain embodiments, the selected set of facility access rules may include that any worker within an area of the facility 202 which has failed to meet at least one prerequisite, for example the worker has been detected by the processor 210 to not be wearing required work gloves or other safety equipment, is deemed a violation of the rule set. The selected set of facility access rules may also include that any worker within the restricted area of the facility 202 that is determined to be performing a prohibited activity as defined by the user may also be a violation of the rule set. According to certain embodiments, the facility access rules may include that a violation is present when a predetermined threshold is exceeded as determined by sensors disposed within the facility 202, when movement is detected within the restricted area by the optical devices or cameras 204, when workers are detected not wearing required personal protection equipment (PPE), or a combination thereof.

As seen from the above, the set of facility access rules may be selectively adjusted to provide different safety thresholds related to determining when an unsafe entry into the restricted area has occurred, namely a first threshold which prohibits the presence of any worker within a restricted area of the facility 202, a second threshold which freely allows workers into a restricted area provided that at least one prerequisite is met, and a third threshold which freely allows workers into a restricted area provided that the workers do not engage in any predetermined or scenario-specific prohibited activities within the restricted area. The set of facility access rules may be selected or adjusted either before or after the real-time facility data is obtained from the facility sensors 208 or cameras 204, according to certain embodiments.

According to certain embodiments, the processor 210 may determine that one or more areas of the facility are to be restricted based on the received facility operation data and the selected set of facility access rules, as at 406. For example, the processor 210 may infer a facility state (e.g., certain equipment that is being operated) based on the facility operation data. The access rules may associate different facility states with facility areas that are restricted from access, e.g., around the active equipment. Human presence in such restricted areas may be undesired as it presents a risk to the health and safety of the human. Accordingly, the processor 210 applying the rules may result in the demarcation 304 of certain areas 306, FIG. 3 of the facility as restricted, based on the facility state.

The method 400 may also include the processor 210 receiving image data representing at least one or more areas that are restricted, as at 408. The cameras 204 may provide such image data. Further, at least some of the cameras 204 may be pointed at non-restricted areas, while others are pointed at restricted areas, and, as noted above, whether and which areas are restricted may depend at least partially on the facility state and the rules applied thereto by the processor 210. According to certain embodiments, the image data may include optical or video data of the restricted areas of the facility 202, related adjacent areas of the facility 202, or specific equipment disposed within the facility 202. For example, a camera 204 may be directed to a catwalk which is used to push pipes directly to a restricted zone. In a further example, a camera 204 may be directed above a floor of the facility 202 to analyze a risk of pipes or other objects coming loose from their rack and falling into the restricted area.

The processor 210 may include artificial intelligence processing capabilities that may detect the presence of a human worker in the restricted area based on the image data from the camera(s) 204. Additionally, depending on the current safety threshold determined by the set of facility access rules, the processor 210 may further determine if the worker within the restricted area has met any predefined safety requirements, or alternatively, if the worker is engaging in a predefined prohibited activity within the restricted area. Accordingly, the processor 210 may review the image data received from the camera(s) 204 that view the restricted areas, and the processor 210 may determine that a person has entered the restricted area and/or has failed to adhere to the set of facility access rules based on the image data, as at 410. According to certain embodiments, the processor 210 may determine that movement of large equipment such as tongs which are meant to be stationary if not being used by a worker would fail to adhere to the set of facility access rules. Equipment which has not been properly stored may also trigger a fail state as determined by the processor 210, according to certain embodiments.

The position of the cameras 204 relative to the restricted areas (e.g., the portion of the field of view of the camera that includes such areas) may also be pre-programmed or otherwise determined by the processor 210 based on the camera 204 position and orientation, facility features, signs, etc. Thus, the location of the worker in the field of view of a camera 104 may be determined and compared to the location of the restricted area in the same field of view. In other embodiments, the mere presence of the worker in the field of view may indicate the worker is present in a restricted area. Furthermore, the cameras 204 may be positioned to compliment one another, e.g., in situations where moving equipment may sometimes temporarily or partially obstruct the view of one or more cameras. In such cases, the processor 210 may be programmed to adjust the view of one or more cameras 204 to account for the obstruction to another camera 204 and maintain view of the restricted area(s). As such, a coordination of the cameras 204 and interpretation of the image data from potentially several cameras simultaneously may be employed to monitor the facility.

At this point, the processor 210 may have determined both that one of the camera 204 views includes a restricted area, and that a worker has entered the restricted area within the camera 204 view. Accordingly, the health and safety of the worker may be at risk, and thus the processor 210 may take a corrective action, such as activating the alarm 206, in response to determining that the person has entered the restricted area, as at 412. According to certain embodiments, the alarm 206 may be disposed in or around the same restricted area as the human worker, however the alarm 206 may also be displayed as an audio or visual indicator on a screen that forms part of system 100, FIG. 1. Upon notification of the alarm 206, the worker may take a reactive measure such as disengaging in their current activity, putting on the required safety equipment, exiting the restricted area, or any other action which mitigates the health and safety risks associated with the operational state of the facility. use of events (video recordings) for pre and post operation briefings in the facility. According to certain embodiments, the corrective action may including using the image data for pre and post operation briefings in the facility 202. For example, safety personnel may tally up the number of alarms and use the image data to show trends to different teams and hold meetings on how to improve behavior near dangerous equipment and restricted zones.

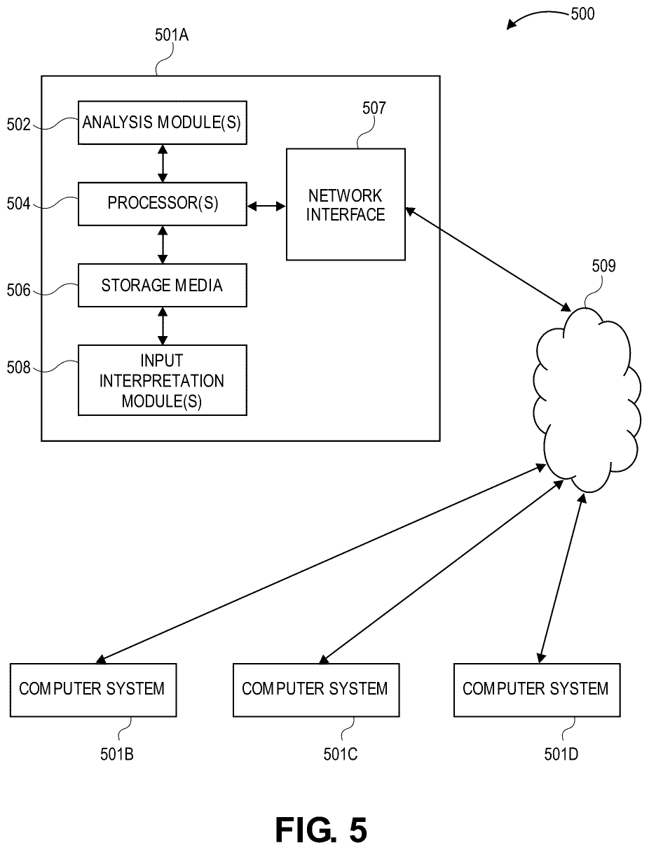

In some embodiments, the methods of the present disclosure may be executed by a computing system. FIG. 5 illustrates an example of such a computing system 500, in accordance with some embodiments. The computing system 500 may include a computer or computer system 501A, which may be an individual computer system 501A or an arrangement of distributed computer systems. The computer system 501A includes one or more analysis modules 502 that are configured to perform various tasks according to some embodiments, such as one or more methods disclosed herein. To perform these various tasks, the analysis module 502 executes independently, or in coordination with, one or more processors 504, which is (or are) connected to one or more storage media 506. The processor(s) 504 is (or are) also connected to a network interface 507 to allow the computer system 501A to communicate over a data network 509 with one or more additional computer systems and/or computing systems, such as 501B, 501C, and/or 501D (note that computer systems 501B, 501C and/or 501D may or may not share the same architecture as computer system 501A, and may be located in different physical locations, e.g., computer systems 501A and 501B may be located in a processing facility, while in communication with one or more computer systems such as 501C and/or 501D that are located in one or more data centers, and/or located in varying countries on different continents).

A processor may include a microprocessor, microcontroller, processor module or subsystem, programmable integrated circuit, programmable gate array, or another control or computing device.

The storage media 506 may be implemented as one or more computer-readable or machine-readable storage media. Note that while in the example embodiment of FIG. 5 storage media 506 is depicted as within computer system 501A, in some embodiments, storage media 506 may be distributed within and/or across multiple internal and/or external enclosures of computing system 501A and/or additional computing systems. Storage media 506 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 500 contains one or more facility safety module(s) 508. In the example of computing system 500, computer system 501A includes the facility safety module 508. In some embodiments, a single facility safety module may be used to perform some aspects of one or more embodiments of the methods disclosed herein. In other embodiments, a plurality of facility safety modules may be used to perform some aspects of methods herein.

It should be appreciated that computing system 500 is merely one example of a computing system, and that computing system 500 may have more or fewer components than shown, may combine additional components not depicted in the example embodiment of FIG. 5, and/or computing system 500 may have a different configuration or arrangement of the components depicted in FIG. 5. The various components shown in FIG. 5 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 500, FIG. 5), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for operating a facility, comprising:
receiving real-time facility data representing an operational state of the facility;
determining that an area of the facility is restricted based on the real-time facility data and a set of facility access rules that associates the operational facility state with at least one restricted area of the facility;
receiving image data representing at least a portion of the restricted area of the facility;
determining if there is a violation of the set of facility access rules based on the received image data; and
taking a corrective action when the violation of the set of facility access rules has been detected.

2. The method of claim 1, further comprising selectively adjusting the set of facility access rules corresponding to the restricted area of the facility.

3. The method of claim 1, further comprising marking a portion of the received image data as the restricted area of the facility, wherein the received image data is displayed within a graphical interface on a screen associated with a user.

4. The method of claim 1, wherein receiving real-time facility data representing an operational state of the facility comprises receiving real-time facility data from at least one sensor associated with the restricted area of the facility.

5. The method of claim 1, wherein determining if there is a violation of the set of facility access rules based on the received image data comprises determining a presence of a human in the restricted area of the facility.

6. The method of claim 5, wherein determining a presence of the human in the restricted area of the facility comprises determining if the human is wearing a set of safety equipment.

7. The method of claim 5, wherein determining a presence of the human in the restricted area of the facility comprises determining if the human is performing a prohibited activity within the restricted area of the facility.

8. The method of claim 7, further comprising adjusting at least one parameter of the prohibited activity within a graphical interface displaying the restricted area of the facility.

9. The method of claim 1, wherein receiving image data representing at least a portion of the restricted area of the facility comprises maintaining a view of the restricted area of the facility by receiving image data in sequence from a plurality of optical devices disposed around the restricted area of the facility.

10. The method of claim 1, wherein taking a corrective action when a violation of the set of facility access rules has been detected comprises activating an alarm within the restricted area of the facility.

11. A computing system, comprising:
one or more processors;
at least one optical device disposed within a facility and communicated to the one or more processors;
at least one sensor disposed within the facility and communicated to the one or more processors; and
a memory system comprising one or more non-transitory computer-readable media storing instructions that, when executed by at least one of the one or more processors, cause the computing system to perform operations, the operations comprising:
receiving real-time facility data representing an operational state of the facility from the at least one sensor;
selectively adjusting a set of facility access rules corresponding to an area of the facility that is to be restricted;
determining that an area of the facility is restricted based on the real-time facility data and the set of facility access rules that associates the operational facility state with at least one restricted area of the facility;
receiving image data representing at least a portion of the restricted area of the facility from the at least one optical device;
determining if there is a violation of the set of facility access rules based on the received image data; and
taking a corrective action when a violation of the set of facility access rules has been detected.

12. The computer system of claim 11, wherein the at least one sensor communicated to the one or more processors comprises:
an optical device;
a pressure sensor;
a temperature sensor;
a motion sensor;
a tachometer;
or operational data received from an outside source communicated to the computer system.

13. The computer system of claim 11, wherein selectively adjusting a set of facility access rules corresponding to the restricted area of the facility comprises selecting a safety threshold for when an unsafe entry into the restricted area has occurred.

14. The computer system of claim 13, wherein selecting a safety threshold for when an unsafe entry into the restricted area has occurred comprises:
determining if a human has entered the restricted area of the facility;
determining that a human has entered the restricted area of the facility but is missing a set of required safety equipment; or
determining that a human has entered the restricted area of the facility but is performing a prohibited activity.

15. The computer system of claim 14, further comprising adjusting at least one parameter of the prohibited activity within a graphical interface displaying the restricted area of the facility, wherein the at least one parameter comprises:
a position of an object within the restricted area of the facility;
a speed of an object within the restricted area of the facility; or
a pressure within the restricted area of the facility.

16. The computer system of claim 11, wherein taking a corrective action when a violation of the set of facility access rules has been detected comprises activating an alarm within a graphical interface displayed on a screen communicated to the at least one or more processors.

17. A non-transitory computer-readable medium storing instructions that, when executed by one or more processors of a computing system, cause the computing system to perform operations, the operations comprising:
receiving real-time facility data representing an operational state of a facility from at least one sensor, wherein the operational facility state comprises at least one piece of equipment within the facility being active;
selectively adjusting a set of facility access rules, wherein the set of facility access rules associates the operational facility state with at least one restricted area of the facility, wherein the set of facility access rules comprises a safety threshold for when an unsafe entry into the restricted area has occurred, and wherein the set of facility access rules is selectively adjusted in response to the operational facility state;
determining that the area of the facility is restricted based on the real-time facility data and the set of facility access rules;
receiving image data representing at least a portion of the restricted area of the facility from at least one optical device, wherein the image data comprises an image of at least a portion of the facility with the determined restricted area marked;
determining if there is a violation of the set of facility access rules based on the received image data, wherein determining if there is a violation of the set of facility access rules based on the received image data comprises determining a presence of a human in the restricted area of the facility; and
taking a corrective action when a violation of the set of facility access rules has been detected, wherein the corrective action comprises generating or transmitting a signal that instructs or causes a physical action to occur, and wherein the physical action comprises activating an alarm within the facility.

18. The non-transitory computer-readable medium of claim 17, wherein determining if there is a violation of the set of facility access rules based on the received image data comprises continually comparing a location of a human within the facility to the marked restricted area of the facility for the duration of the operational state of the facility.

19. The non-transitory computer-readable medium of claim 17, wherein taking a corrective action when a violation of the set of facility access rules has been detected comprises taking a corrective action when at least one of the following has occurred:
a human has been detected entering the restricted area of the facility;
a human has been detected entering the restricted area of the facility and is missing a set of required safety equipment; or
a human has been detected entering the restricted area of the facility and is performing a prohibited activity.

20. The non-transitory computer-readable medium of claim 17, wherein receiving image data representing at least a portion of the restricted area of the facility from the at least one optical device comprises maintaining the restricted area of the facility in view of at least one optical device for the duration of the operational state of the facility.
